(19) United States
(12) Patent Application Publication
(10) Pub. No.: US 2002/0030030 A1
(43) Pub. Date: Mar. 14, 2002

(54) LIQUID CONTAINER WITH TEMPERATURE SENSOR

(76) Inventor: ARNOLD EDWARD REES, NEWCASTLE-UPON-TYNE (GB)

Correspondence Address: LARSON & TAYLOR, PLC, 1199 NORTH FAIRFAX STREET, SUITE 900, ALEXANDRIA, VA, 22314, US

(21) Appl. No.: 09/423,083

(22) PCT Filed: Apr. 22, 1998
(86) PCT No.: PCT/GB98/01165

(30) Foreign Application Priority Data
May 2, 1997 (GB) 9709028.6

(51) Int. Cl. A61J 9/02

(52) U.S. Cl. 215/11.2; 374/150

(57) ABSTRACT

A container for liquid, and in particular a baby's feeding bottle, comprises a bounding wall (2) defining a hollow interior to the container, part (6) of said bounding wall (2) consisting of a material which undergoes a change in color when the temperature thereof reaches a predetermined value. Preferably the bounding wall (2) is of a transparent plastics material and the color change material is in the form of a narrow stripe

### TECHNICAL FIELD

This invention relates to a baby feeding bottle incorporating means for providing an indication of the temperature of the content of the bottle.

### BACKGROUND ART

It is essential to ensure that the content of a feeding bottle is not too hot prior to feeding the content to a baby.

There are a variety of arrangements currently available for providing an indication of whether or not the temperature of the content of a baby feeding bottle exceeds a predetermined allowable value.

A number of these current arrangements utilise the fact that various materials undergo a change in colour when the temperature of the material exceeds a given value.

A first known arrangement of this type consists of a stick-on label for application to the exterior of a feeding bottle and incorporating an LCD display which changes colour at a known temperature.

However, such labels suffer from a number of disadvantages, in that they must be bought in separately by the bottle manufacturer, and, being separate from the bottle, they have a tendency to come off the bottle and become lost.

Additionally, baby feeding bottles are often sterilised in microwave ovens, and such heat treatment can affect the display of the labels.

The labels, being on the outside of the bottle, are not in direct contact with the liquid content of the bottle, and consequently give a readout dependent upon the heat transfer characteristics of the bottle, which can differ for different materials.

A second known arrangement utilises LCD labels of the above type, but the labels are cast into the surface of the bottle with a plastic resin. This clearly eliminates the possibility of the label coming unstuck from the bottle and being lost, but involves an expensive manufacturing process. Again, the liquid content of the bottle is not in direct contact with the label.

A third known arrangement involves the application of temperature sensitive inks or paints to the outer surface of the bottle, the ink or paint incorporating a coloured pigment such that the display, which is typically of a cartoon format, changes colour at a given temperature.

The inks or paints are conveniently screen-printed onto the bottle, and tend to come off quite easily resulting in the products having a relatively short effective working life.

As with the label arrangement, there is no direct contact between the temperature sensitive ink or paint and the content of the bottle.

### DISCLOSURE OF THE INVENTION

It would be desirable to be able to provide a baby feeding bottle incorporating temperature sensing means which overcame the disadvantages of the current arrangements and which was cheap and easy to manufacture.

According to the present invention there is provided an infant feeding container comprising a bounding wall of a plastics material defining a hollow interior to the container, characterised in that the container is blow-moulded from a transparent plastics material, part of the bounding wall including temperature sensitive coloured pigments added to the transparent plastics material whereby, when the temperature of the bounding wall reaches a predetermined value, said part of the bounding wall undergoes a change in colour, the rest of the bounding wall remaining transparent.

Preferably the part of the bounding wall comprises at least one narrow stripe extending substantially the length of the bottle.

The coloured pigments may be such as to undergo a first change in colour at a first predetermined temperature, and a second change in colour at a second, higher temperature.

### BRIEF DESCRIPTION OF THE DRAWINGS

FIGS. 1 and 2 show two alternative bottles according to the invention.

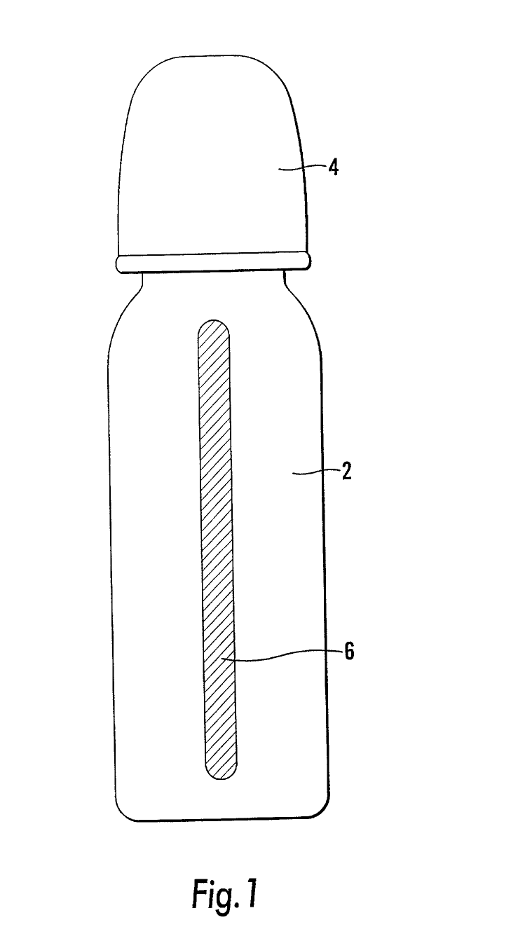

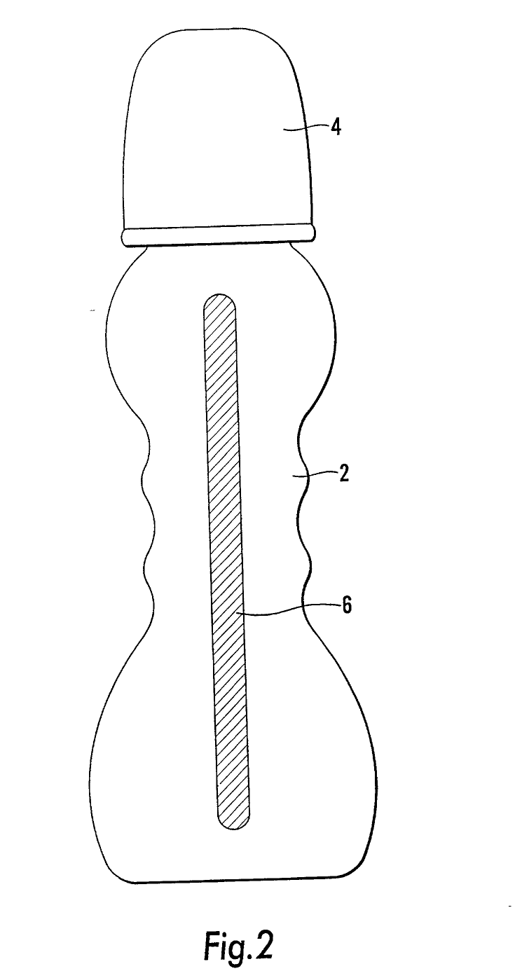

### DETAILED DESCRIPTION OF THE PREFERRED EMBODIMENTS

Referring to the drawings, the illustrated baby feeding bottles are of conventional shape, comprising an open-topped bottle portion 2 closed by a cap 4 which can be replaced by a teat for feeding purposes.

The bottle portion 2 is typically manufactured from a transparent plastics material such as polycarbonate, although polyethylene or polypropylene could also be used.

The bottle portion 2 includes a vertical stripe 6 of a material that undergoes a change in colour when its temperature reaches a predetermined value.

More particularly, the stripe 6 comprises the same transparent material as the remainder of the bottle portion 2 but to which has been added, during the blow moulding or other manufacturing procedure, coloured pigments which render the stripe 6 opaque and coloured, these pigments being temperature sensitive in that they change colour at a given temperature, typically 37° C., the preferred feeding temperature of milk.

Thus it will be appreciated that, if the temperature of the content of the bottle portion 2, which is in direct contact with the bottle portion, exceeds the given temperature, the stripe 6 will be one particular colour—for example red—indicating that the content is too hot for feeding to a baby, and, if the temperature is equal to or below said temperature, the stripe will be another colour—for example, blue.

In practice the material of the stripe 6 will change from one colour to another over a range of temperatures, typically 33 to 38° C., the change being completed at 38° C.

Clearly the precise configuration, location and numbers of the stripe 6 can be chosen to suit particular requirements, while the material of the stripe may be such as to undergo two colour changes on an increase in temperature. In such a situation, the first colour could indicate that the content of the bottle portion 2 is too cold for consumption, the second colour could indicate that the content is at a suitable temperature for consumption, and the third colour could indicate that the content is too hot for consumption.

The described bottle is extremely easy and cheap to manufacture, in that existing tooling can be used, it merely being necessary to modify the moulding machine to provide the stripe 6 (or equivalent) and to add coloured pigment to that part of the plastics material to form the stripe.

The stripe 6 is an integral part of the bottle portion 4, and cannot therefore be mislaid, while the stripe 6 is in direct contact with the liquid under test, and the colour of the stripe 6 is therefore a direct indication of the temperature of the content.

The provision of a temperature sensitive stripe 6 or the like can also be used to provide an indication of when the liquid content of the bottle portion 4 is ready for consumption if it is known to be too hot at the outset. For example, if almost boiling liquid is poured into the bottle portion 4, the stripe 6 will very quickly change to the colour indicative of the content being at a temperature above 37° C. The colour of the stripe 6 can be monitored until it changes to its normal colour, meaning that the content has cooled to a consumable temperature.

1. An infant feeding container comprising a bounding wall (2) of a plastics material defining a hollow interior to the container, characterised in that the container is blow-moulded from a transparent plastics material, part (6) of the bounding wall (2) including temperature sensitive coloured pigments-added to the transparent plastics material whereby, when the temperature of the bounding wall (2) reaches a predetermined value, said part (6) of the bounding wall (2) undergoes a change in colour, the rest of the bounding wall (2) remaining transparent.

2. A container as claimed in claim 1 in which the part of the bounding wall (2) comprises at least one narrow stripe (6) extending substantially the length of the container.

3. A container as claimed in claim 1 or claim 2 in which the coloured pigments are such as to undergo a first change in colour at a first predetermined temperature, and a second change in colour at a second, higher temperature.
